(19) United States
(12) Patent Application Publication
(10) Pub. No.: US 2025/0356125 A1
(43) Pub. Date: Nov. 20, 2025

(54) MACHINE LEARNING MODEL WITH CONSTRAINED OUTPUT TOKEN VOCABULARY

(71) Applicant: Microsoft Technology Licensing, LLC, Redmond, WA (US)

(72) Inventors: Eric Joel HORVITZ, Portola Valley, CA (US); Harsha Prasad NORI, Seattle, WA (US)

(73) Assignee: Microsoft Technology Licensing, LLC, Redmond, WA (US)

(21) Appl. No.: 18/966,018

(22) Filed: Dec. 2, 2024

Related U.S. Application Data
(60) Provisional application No. 63/649,908, filed on May 20, 2024.

(51) Int. Cl. G06F 40/284

(52) U.S. Cl. CPC G06F 40/284

(57) ABSTRACT

A computing system including one or more processing devices configured to receive a prompt. At a machine learning model that has an output token vocabulary including candidate output tokens, the one or more processing devices are further configured to compute output token probabilities over the output token vocabulary based at least in part on the prompt. At a decoder plugin, the one or more processing devices are further configured to compute a constrained output token vocabulary as a proper subset of the output token vocabulary. The one or more processing devices are further configured to select output tokens based at least in part on the computed output token probabilities. The output tokens are selected from among the candidate output tokens included in the constrained output token vocabulary. The one or more processing devices are further configured to transmit an output including the output tokens to an additional computing process.

### CROSS REFERENCE TO RELATED APPLICATIONS

This application claims priority to U.S. Provisional Patent Application Ser. No. 63/649,908, filed May 20, 2024, the entirety of which is hereby incorporated herein by reference for all purposes.

### BACKGROUND

In machine learning environments, prompting is the typical approach used to control the outputs of large language models (LLMs) and large multimodal models (LMMs). When prompting is used, the user supplies a text input, usually in the form of natural language, which is converted into input tokens. The input tokens are then processed at a machine learning model to generate a probability distribution of potential output tokens. An output token is sampled from the probability distribution for inclusion in an output presented to the user. The output token may also be treated as though it were included in the tokenized input when iteratively generating outputs that include multiple output tokens. Thus, the output is generated in an autoregressive manner in which the machine learning model uses previously generated output tokens as inputs when generating later output tokens.

### SUMMARY

According to one aspect of the present disclosure, a computing system is provided, including one or more processing devices configured to receive a prompt. At a machine learning model that has an output token vocabulary including a plurality of candidate output tokens, the one or more processing devices are further configured to compute a plurality of output token probabilities over the output token vocabulary based at least in part on the prompt. At a decoder plugin, the one or more processing devices are further configured to compute a constrained output token vocabulary as a proper subset of the output token vocabulary. The one or more processing devices are further configured to select one or more output tokens based at least in part on the computed output token probabilities. The one or more output tokens are selected from among the candidate output tokens included in the constrained output token vocabulary. The one or more processing devices are further configured to transmit an output including the one or more output tokens to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to execute a machine learning model and a decoder plugin, according to one example embodiment.

FIG. 2 schematically shows an example in which guidance logic is executed to constrain an output token vocabulary, according to the example of FIG. 1.

FIG. 3 schematically shows the computing system in an example in which constrained output token probabilities are computed, according to the example of FIG. 1.

FIG. 4 schematically shows a decoder plugin configured to constrain the machine learning model to outputting valid chess moves, according to the example of FIG. 1.

FIG. 5A schematically shows the computing system in an example in which the decoder plugin includes an oversight machine learning model, according to the example of FIG. 1.

FIG. 5B schematically shows an example of candidate output token classification when the oversight machine learning model is a toxicity classifier, according to the example of FIG. 5A.

FIG. 6 schematically shows the computing system in an example in which the decoder plugin includes an oversight machine learning model and a reward model, according to the example of FIG. 1.

FIG. 7 schematically shows the computing system in an example in which the one or more processing devices are configured to execute a search algorithm when computing the constrained output token vocabulary, according to the example of FIG. 1.

FIG. 8 schematically shows the computing system in an example in which the decoder plugin is generated at least in part at the machine learning model, according to the example of FIG. 1.

FIG. 9A shows a flowchart of a method for use with a computing system to constrain the output token vocabulary of a machine learning model, according to the example of FIG. 1.

FIGS. 9B-9F show additional steps of the method of FIG. 9A that may be performed in some examples.

FIG. 10 shows a schematic view of an example computing environment in which the computing system of FIG. 1 may be instantiated.

### DETAILED DESCRIPTION

Although prompting provides users with a flexible and easily understandable means of controlling LLMs and LMMs, prompting has shortcomings that limit its effectiveness in many settings. One such shortcoming is hallucination, in which an LLM or LMM generates outputs that are factually inaccurate despite resembling text included in the training data of the machine learning model. For example, LLMs and LMMs sometimes generate citations of nonexistent references when generating academic text in which citations are likely to occur.

Hallucination may be difficult to avoid by relying solely on prompting as a technique for controlling machine learning model outputs. Since the next-token predictions of the machine learning model depend upon its own previously generated output tokens, inaccuracies in the output of the machine learning model may compound by influencing the probability distributions from which later output tokens are selected. Thus, errors in the outputs of the machine learning model may become increasingly likely as the number of tokens in the context increases. This autoregressive drift may be unavoidable with conventional prompt engineering techniques. In addition, since hallucinations typically have the superficial appearance of factually correct information, a user may be unaware that an output is a hallucination unless the user performs further fact-checking.

As another consequence of the autoregressive drift discussed above, planning is typically difficult for existing LLMs and LMMs. For example, when an LLM or LMM is instructed by the user to play a board game, the machine learning model may make errors in its representation of the game state and may accordingly attempt to make invalid moves. At existing machine learning models, obtaining a valid move as output may require additional prompting, which consumes additional computing resources and may be time-consuming for the user.

Limited context window size may also interfere with planning at LLMs and LMMs. When the total number of tokens included in the prompt and output exceeds a context window size, the machine learning model may be unable to condition its outputs on earlier portions of its context and may therefore fail to account for information included in those earlier portions. This forgetting may be exacerbated when multi-shot prompting is used or when the user instructs the machine learning model to regenerate portions of its output.

Current approaches to machine learning model control also encounter difficulties in preventing machine learning models from producing harmful outputs. For example, a developer of a machine learning model may intend to prevent the model from outputting responses that encourage illegal activities, leak personally identifying information, give advice that would be dangerous for the user to follow, or can be used to harass other people. One existing approach to harmful output prevention is reinforcement learning from human feedback (RLHF), in which additional training is performed at a machine learning model using a reward model trained on human-provided classifications. However, RLHF suffers from several drawbacks including high cost and susceptibility to circumvention with specialized prompts.

Another prior approach to harmful output prevention relies on a harmfulness classifier that is applied to the outputs of the machine learning model after those outputs have been generated. The harmfulness classifier may instruct the machine learning model to regenerate the output if the output is classified as having a high probability of being harmful. However, regenerating the output may be computationally expensive, especially in scenarios in which the output is regenerated multiple times.

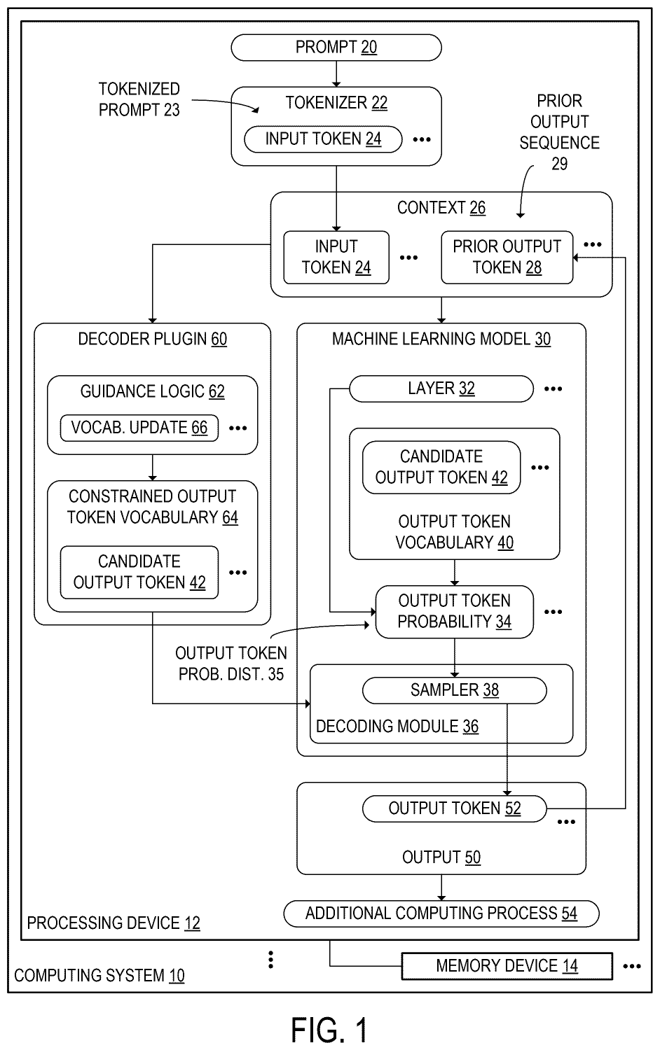

In order to address the shortcomings of existing machine learning model control techniques, a computing system 10 is provided, as schematically depicted in the example of FIG. 1. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices.

In some examples, the one or more processing devices 12 and/or the one or more memory devices 14 may include a plurality of physical components distributed among a plurality of different physical computing devices. For example, the one or more processing devices 12 and/or the one or more memory devices 14 may be included in a networked system of multiple physical computing devices located in a data center. Portions of the functionality of the one or more processing devices 12 and/or the one or more memory devices 14 may additionally or alternatively be performed at one or more client computing devices.

The one or more processing devices 12 are configured to receive a prompt 20. For example, the prompt 20 may be received in natural language form. In some examples, the prompt 20 may be entered by a user at a user interface. In other examples, the prompt 20 may be programmatically generated at another computing process and may be received from that other computing process via an application-programming interface (API).

The one or more processing devices 12 are further configured to execute a tokenizer 22 to compute a tokenized prompt 23 based at least in part on the prompt 20. The tokenized prompt 23 includes a plurality of input tokens 24, which may, for example, indicate words, portions of words, or other characters such as digits or punctuation marks. The tokenizer 22 is accordingly configured to encode the prompt 20 in a form that is usable as input to a machine learning model 30.

The machine learning model 30 executed at the one or more processing devices 12 may, for example, be an LLM or an LMM. As shown in the example of FIG. 1, the machine learning model 30 is structured as a deep neural network that includes a plurality of layers 32. For example, the machine learning model 30 may be a transformer network. Alternatively, some other architecture may be used for the machine learning model 30.

The machine learning model 30 has an output token vocabulary 40 including a plurality of candidate output tokens 42. The candidate output tokens 42 included in the output token vocabulary 40 are the tokens that are eligible to be included in outputs of the machine learning model 30. In some examples, the output token vocabulary 40 may include the same tokens as an input token vocabulary with which the tokenizer computes the tokenized prompt 23.

Based at least in part on the tokenized prompt 23, the machine learning model 30 is configured to compute a plurality of output token probabilities 34 over the output token vocabulary 40. For example, the machine learning model 30 may be configured to generate logits as outputs of its final layer 32. These logits are non-normalized prediction values. The machine learning model 30 may be further configured to apply a normalization function to the logits to compute the output token probabilities 34. The output token probabilities form an output token probability distribution 35.

The machine learning model 30 further includes a sampler 38 at which the one or more processing devices 12 are configured to sample output tokens 52 from the output token probability distribution 35. The sampler 38 may be included in a decoding module 36. Accordingly, the one or more processing devices 12 are configured to select the one or more output tokens 52 based at least in part on the computed output token probabilities 34. In some examples, the output token probabilities 34 transmitted to the sampler 38 are a predetermined number of highest probabilities predicted for corresponding candidate output tokens 42 at the machine learning model 30. For example, the decoding module 36 may be configured to select the top 8 or top 16 output token probabilities 34.

At the machine learning model 30, the one or more processing devices 12 are configured to compute the one or more output token probabilities 34 in each of a plurality of autoregressive generation iterations 44. Over the autoregressive generation iterations 44, the one or more processing devices 12 are configured to compute an output 50 including a plurality of the output tokens 52. As shown in the example of FIG. 1, the input tokens 24 included in the tokenized prompt 23 are input into the machine learning model 30 as part of a context 26. At each of the autoregressive generation iterations 44 following a first autoregressive generation iteration 44, the context 26 used as input to the machine learning model 30 further includes a prior output sequence 29. The prior output sequence 29 includes one or more prior output tokens 28 computed as the output tokens 52 at prior autoregressive generation iterations 44.

Subsequently to generating the output 50, the one or more processing devices 12 are further configured to transmit the output 50 to an additional computing process 54. For example, the additional computing process 54 may be a graphical user interface (GUI) at which the output 50 is displayed to the user. As another example, the one or more processing devices 12 may be configured to transmit the output 50 to a compiler at which the output is compiled into assembly-level instructions.

The one or more processing devices 12 are further configured to execute a decoder plugin 60 when generating the output 50 at the machine learning model 30. At the decoder plugin 60, the one or more processing devices 12 are configured to execute guidance logic 62 to compute a constrained output token vocabulary 64. The constrained output token vocabulary 64 is a proper subset of the output token vocabulary 40. As discussed in examples provided below, the guidance logic 62 may utilize a wide variety of different types of programming logic to compute the constrained output token vocabulary 64.

At the sampler 38 of the machine learning model 30, the one or more processing devices 12 are configured to select the one or more output tokens 52 from among the candidate output tokens 42 included in the constrained output token vocabulary 64. The decoder plugin 60 therefore provides additional control over the output 50 of the machine learning model 30 by narrowing the set of candidate output tokens 42 that may be selected as the one or more output tokens 52 to those included in the constrained output token vocabulary 64.

In some examples, at the decoder plugin 60, the one or more processing devices 12 may be further configured to iteratively update the constrained output token vocabulary 64 at each of a plurality of the autoregressive generation iterations 44. The constrained output token vocabulary 64 may be updated based at least in part on the context 26 as additional prior output tokens 28 are added. For example, as discussed in further detail below, the additional prior output tokens 28 may inform the predictions of a toxicity classifier that is included in the decoder plugin 60 and is used to select the constrained output token vocabulary 64.

The guidance logic 62 may, in some examples, be configured to compute the constrained output token vocabulary 64 at least in part by computing a vocabulary update 66 that specifies a modification to the output token vocabulary 40. The vocabulary update 66 may be stored in the one or more memory devices 14 for later use, such as for one or more other prompts 20 or autoregressive generation iterations 44. The one or more memory devices 14 may, in such examples, store a library of precomputed vocabulary updates 66. In some examples, the constrained output token vocabulary 64 may be computed at least in part by applying multiple stored vocabulary updates 66 to the output token vocabulary 40 to the output token vocabulary 40. Multiple precomputed changes to the output token vocabulary 40 are accordingly applied in such examples.

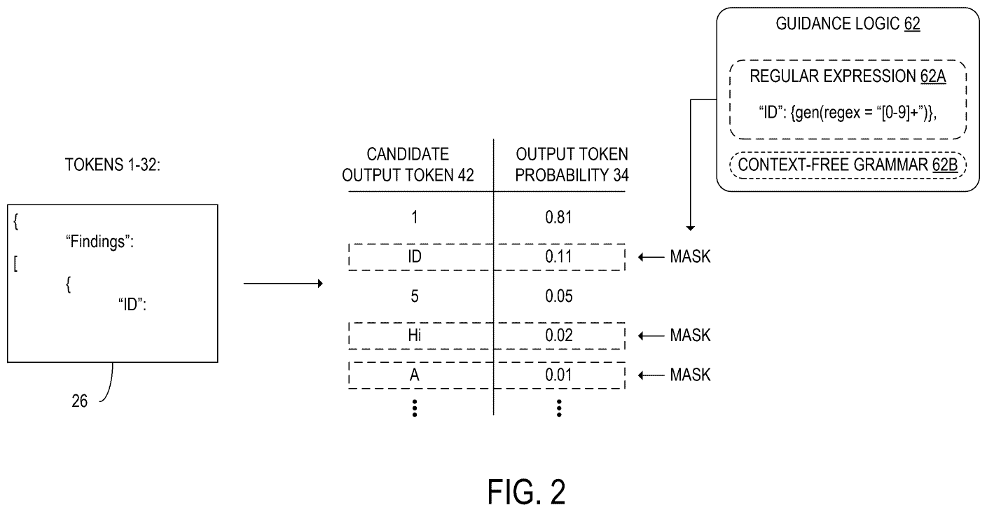

FIG. 2 schematically shows an example in which guidance logic 62 is executed to constrain an output token vocabulary 40. In the example of FIG. 2, the context 26 includes 32 tokens that form the beginning of a JavaScript Object Notation (JSON) template:

```
{
  “Findings”:
[
  {
    “ID”:
```

The one or more processing devices 12 are configured to compute a set of output token probabilities 34 for respective candidate output tokens 42 that are predicted as potential next tokens in the template. In this example, the candidate output tokens 42 include “1,” “ID,” “5,” “Hi,” and “A.”

The one or more processing devices 12 are further configured to execute guidance logic 62 to select one or more of the candidate output tokens 42 to mask as invalid output tokens. Thus, the one or more processing devices 12 are configured to compute the constrained output token vocabulary 64. For example, the one or more processing devices 12 may be configured to specify the constrained output token vocabulary 64 with a regular expression 62A or a context-free grammar 62B. The regular expression 62A, according to the example of FIG. 2, is the regular expression “ID”: {gen(regex=“[0-9]+”)}, which specifies that the next output token 52 is a digit between 0 and 9, inclusive. This regular expression 62A is applied to a specific field in the template.

In examples in which the guidance logic 62 is a context-free grammar 62B, the context-free grammar 62B may be applied to the template as a whole and may specify properties of syntactically valid JSON. The one or more processing devices 12 are accordingly configured to make the machine learning model 30 more likely to generate a syntactically valid template by constraining the output token vocabulary 40. In other examples, rather than a regular expression 62A or a context-free grammar 62B, the guidance logic 62 may be specified in a Turing-complete language.

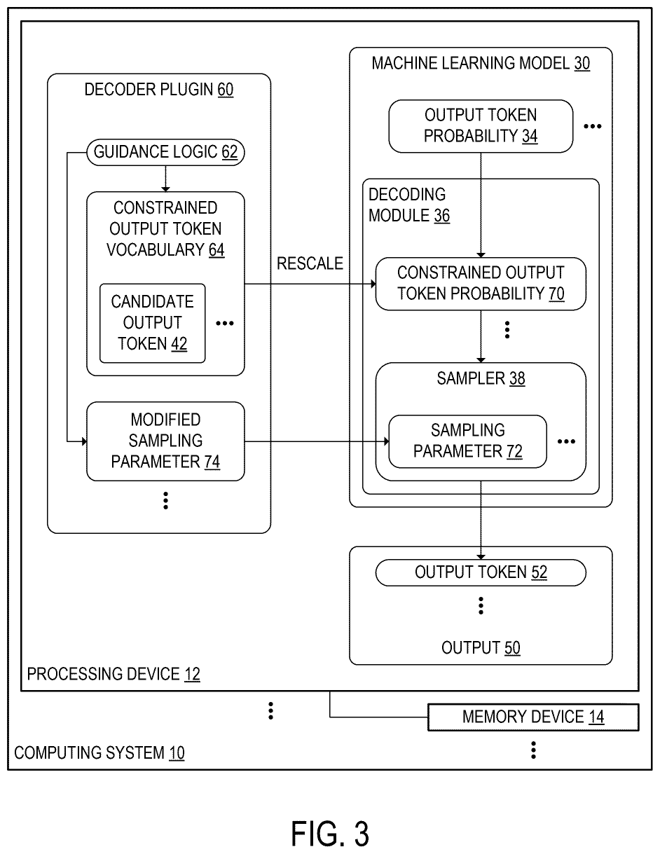

FIG. 3 schematically shows the computing system 10 in an example in which additional modifications are performed at the decoding module 36 of the machine learning model 30. At the decoding module 36, the one or more processing devices 12 may be further configured to rescale the output token probabilities 34 to obtain constrained output token probabilities 70 for the candidate output tokens 42. The constrained output token probabilities 70 may be normalized over the constrained output token vocabulary 64. Thus, at the sampler 38, the one or more processing devices 12 may be configured to sample the one or more output tokens 52 according to the constrained output token probabilities 70.

In some examples, rather than entirely excluding one or more of the candidate output tokens 42 from inclusion in the output 50, the one or more processing devices 12 may instead be configured to decrease the output token probabilities 34 of the machine learning model 30 outputting those one or more candidate output tokens 42 without reducing those output token probabilities 34 to zero. In such examples, at the decoder plugin 60, the one or more processing devices 12 may be configured to modify the respective output token probabilities 34 associated with the plurality of candidate output tokens 42 to thereby obtain the constrained output token probabilities 70. The guidance logic 62, in such examples, may identify one or more candidate output tokens 42 for which the one or more processing devices 12 are configured to reduce the corresponding output token probabilities 34. The guidance logic 62 may additionally or alternatively identify one or more candidate output tokens 42 for which the one or more processing devices 12 are configured to increase the corresponding output token probabilities 34. In such examples, the one or more processing devices 12 are further configured to select the one or more output tokens 52 based at least in part on the constrained output token probabilities 70.

In the example of FIG. 3, the one or more processing devices 12 are further configured to modify one or more sampling parameters 72 of the machine learning model 30. The one or more sampling parameters are parameters that are used during selection of output tokens 52 from the output token probability distribution 35 in order to determine which output tokens 52 are selected. For example, the one or more sampling parameters 72 may include a temperature. At the decoder plugin 60, the one or more processing devices 12 may be configured to compute one or more modified sampling parameters 74 that replace the one or more sampling parameters 72 used at the sampler 38. For example, one or more modified sampling parameters 74 may be used when the user instructs the machine learning model 30 to generate multiple different completions of the context 26. In such examples, the decoder plugin 60 may increase the temperature to increase the variety of the outputs 50 or may decrease the temperature to increase the consistency of the outputs 50.

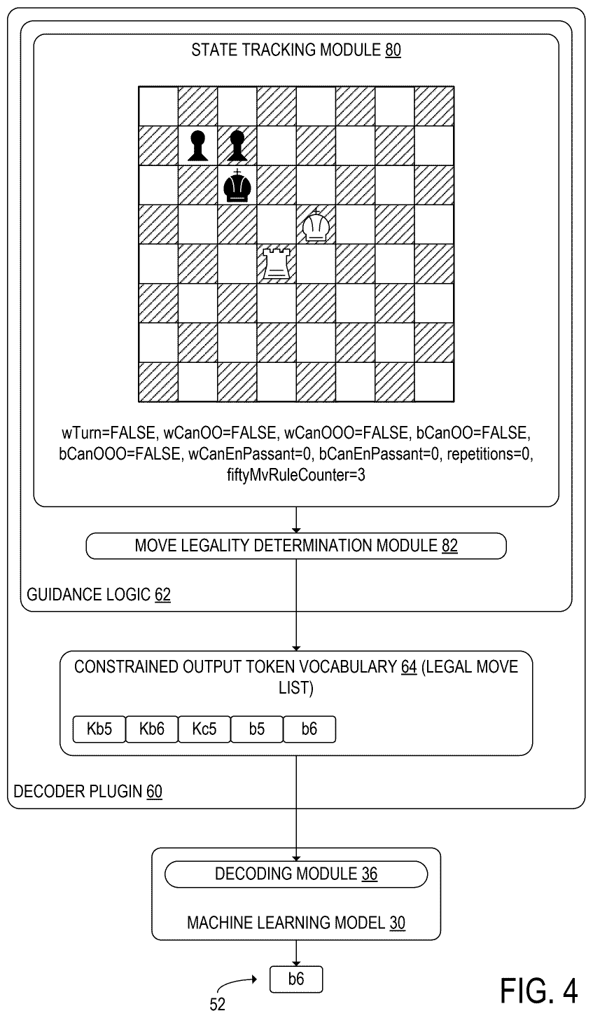

FIG. 4 schematically shows another example of the decoder plugin 60.

In the example of FIG. 4, the machine learning model 30 is instructed to play chess, and the decoder plugin 60 is configured to constrain the machine learning model 30 to outputting valid chess moves. Existing autoregressive machine learning models trained to play chess typically undergo autoregressive drift as the game progresses. Accordingly, such models frequently lose track of the game state and start outputting invalid moves. The user may have to further prompt the machine learning model to correct the representation of the game state and steer its outputs back toward legal chess moves. This additional prompting interrupts the user experience and consumes additional time and computing resources.

The guidance logic 62 of the decoder plugin 60 in the example of FIG. 4 includes a state tracking module 80 that stores a specification of a board state, including piece locations. The state tracking module 80 further stores values of other variables that affect chess move legality, such as which player's turn it is. The data stored in the state tracking module 80 is used as an input to a move legality determination module 82 at which the one or more processing devices 12 are configured to compute the constrained output token vocabulary 64 as a legal move list. At the machine learning model 30, the one or more processing devices 12 are configured to select the next output token 52 from among the chess moves listed as legal moves in the constrained output token vocabulary 64.

As the chess game progresses, the one or more processing devices 12 are configured to update the state tracking module 80 and recompute the legal move list at the move legality determination module 82. Thus, by incorporating deterministic tracking of move legality, the decoder plugin 60 constrains the machine learning model 30 to outputting legal chess moves. The machine learning model 30 is accordingly less likely to require additional prompting to successfully play chess with the user.

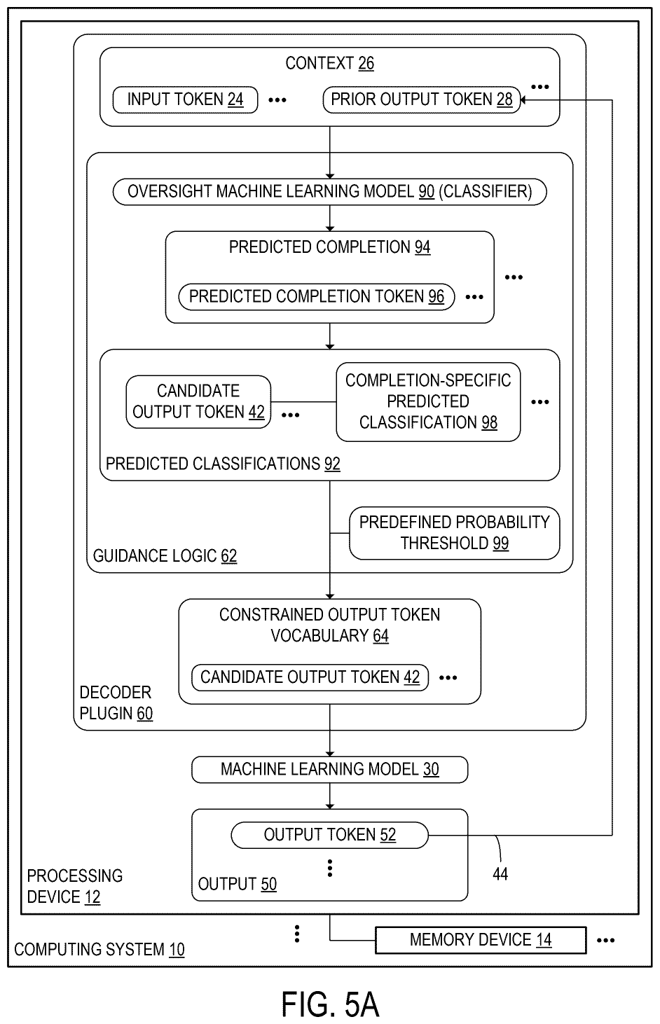

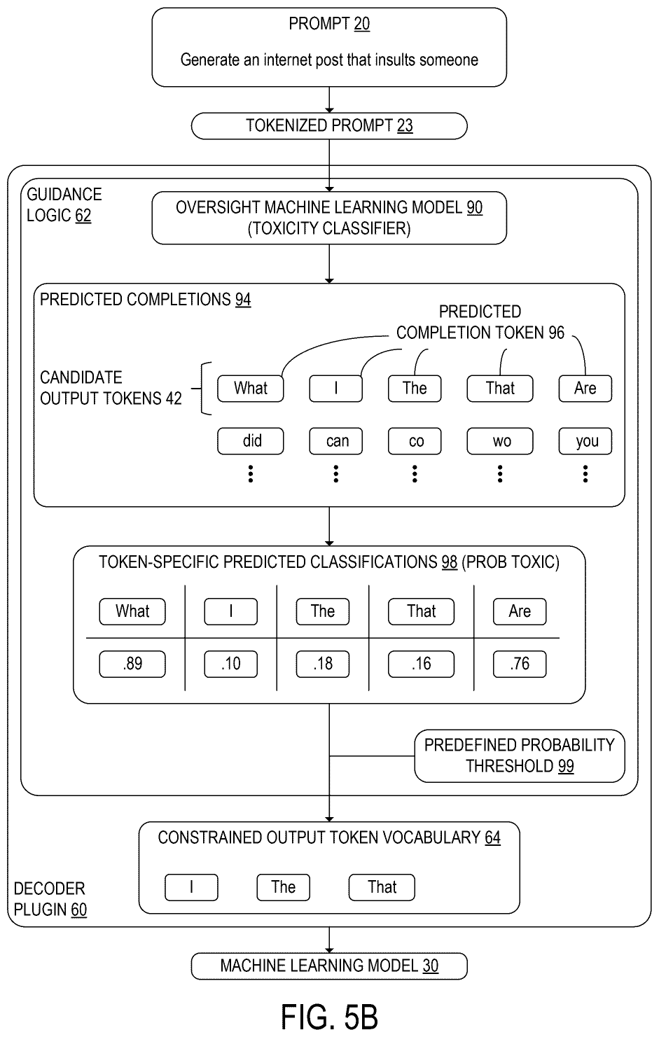

FIG. 5A schematically shows the computing system 10 in an example in which the decoder plugin 60 includes an oversight machine learning model 90. In the example of FIG. 5A, the oversight machine learning model 90 is a classifier. At the oversight machine learning model 90, the one or more processing devices 12 are further configured to compute a predicted classification 92 of the output 50 of the machine learning model 30. This predicted classification 92 may be conditioned on the context 26. The oversight machine learning model 90 may, for example, be smaller than the machine learning model 30 in terms of parameter count and may accordingly have lower computational costs associated with inferencing. The oversight machine learning model 90 may therefore be used to heuristically screen the potential outputs 50 of the machine learning model 30 in a manner that is lower cost than generating multiple different outputs 50 of the machine learning model 30 and selecting between those outputs 50.

In some examples, when estimating the predicted classification 92, the one or more processing devices 12 may be configured to compute a predicted completion 94 of the context 26. The predicted completion 94 may include a sequence of predicted completion tokens 96. The oversight machine learning model 90 may, for example, be configured to generate the predicted completion 94 in examples in which the oversight machine learning model 90 is a lower-capability but lower-inferencing-cost LLM or LMM. The one or more processing devices 12 may be configured to generate a plurality of different predicted completions 94 in some examples.

In the example of FIG. 5A, the one or more processing devices 12 are further configured to compute a plurality of completion-specific predicted classifications 98 at the oversight machine learning model 90. The completion-specific predicted classifications 98 are respectively associated with the predicted completions 94. The oversight machine learning model 90 may compute the completion-specific predicted classifications 98 as a vector of probabilities associated with respective classes.

The one or more processing devices 12 may be further configured to select the constrained output token vocabulary 64 based at least in part on the completion-specific predicted classifications 98. For example, the candidate output tokens 42 selected for inclusion in the constrained output token vocabulary 64 may be one or more candidate output tokens 42 located at the beginnings of one or more of the predicted completions 94. Those candidate output tokens 42 may be those that are predicted to lead to outputs 50 that have an indicated completion-specific predicted classification 98 with a probability above or below a predefined probability threshold 99. For example, the one or more processing devices 12 may be configured to determine the probabilities that the prediction completions 94 leak personally identifying information. The one or more processing devices 12 may be further configured to exclude one or more candidate output tokens 42 from the constrained output token vocabulary 64 if the completion-specific predicted classifications 98 for predicted completions 94 beginning with those candidate output tokens 42 are above the predefined probability threshold 99.

In some examples, the oversight machine learning model 90 may be configured to compute the predicted classification 92 of the output 50 without also computing the predicted completion 94. For example, the oversight machine learning model 90 may be trained on training data including a plurality of context-classification pairs. Those context-classification pairs may each indicate whether the machine learning model 30 generated an output 50 of a specific type (e.g., an output labeled as harmful by a human) when the context 26 included in that context-classification pair was used as input. In such examples, the guidance logic 62 may include respective constrained output token vocabularies 64 that are used when such classes are detected, or instructions to generate such constrained output token vocabularies 64.

FIG. 5B shows an example of candidate output token classification when the oversight machine learning model 90 is a toxicity classifier. In the example of FIG. 5B, the user enters a prompt, “Generate an internet post that insults someone,” that would lead to a toxic output if followed without oversight. The one or more processing devices 12 are configured to tokenize the prompt 20 into a tokenized prompt 23, which is input into the oversight machine learning model 90.

The oversight machine learning model 90 is configured to generate multiple different predicted completions 94 that each include a plurality of predicted completion tokens 96 selected from among the candidate output tokens 42 included in the output token vocabulary 40 of the machine learning model 30. The oversight machine learning model 90 and the machine learning model 30 have the same output token vocabulary 40 in the example of FIG. 5B.

The oversight machine learning model 90 is further configured to compute token-specific predicted classifications 98 associated with the respective first tokens of the predicted completions 94. The token-specific predicted classifications 98 in the example of FIG. 5B indicate probabilities that the output 50 is toxic conditional on beginning the output 50 with that predicted completion token 96. In some examples, the oversight machine learning model 90 is further configured to compute token-specific predicted classifications 98 for one or more subsequent predicted completion tokens 96.

The one or more processing devices 12 are further configured to compare the token-specific predicted classifications 98 to a predefined probability threshold 99 and exclude the corresponding predicted completion tokens 96 from the constrained output token vocabulary 64 if those predicted completion tokens 96 have probabilities of being toxic that are above the predefined probability threshold. In the example of FIG. 5B, the oversight machine learning model 90 generates predicted completions that begin with the tokens “What,” “I,” “The,” “That,” and “Are.” The one or more processing devices 12 predict that beginning the output 50 with “What” or “Are” has a probability of producing a toxic output that is above the predefined probability threshold 99, and accordingly excludes “What” and “Are” from the constrained output token vocabulary 64. The machine learning model 30 is accordingly configured to select an output token 52 from among “I,” “The,” and “That.”

In some examples, the one or more processing devices 12 may be configured to execute the oversight machine learning model 90 when generating each output token 52. In other examples, the one or more processing devices 12 may be configured to execute the oversight machine learning model 90 at a specified interval, such as every 10 tokens or every 20 tokens. Thus, the one or more processing devices 12 may be configured to steer the generation of the output 50 away from toxic responses without incurring the computational costs associated with running the oversight machine learning model 90 at every output token 52.

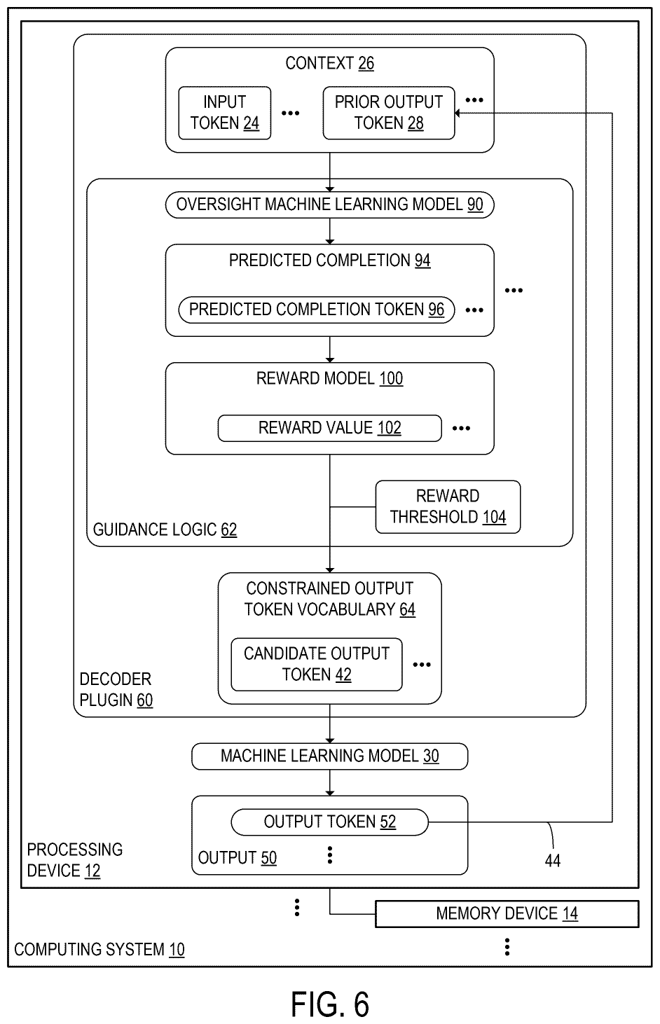

In some examples, as depicted in the example of FIG. 6, an oversight machine learning model 90 may be included along with a reward model 100 in the decoder plugin 60. At the oversight machine learning model 90, the one or more processing devices are configured to compute one or more predicted completions 94 of the context 26, as in the example of FIGS. 5A-5B. The predicted completions 102 each include a plurality of predicted completion tokens 96.

At a reward model 100, the one or more processing devices 12 are further configured to compute a respective reward value 102 associated with each of the one or more predicted completions 94. The reward model 100 may, for example, be a machine learning model trained using human-assigned reward scores associated with samples of training text. In other examples, the reward scores used to train the reward model 100 may be generated at least in part at another machine learning model that receives prompts including the corresponding text samples. The reward model 100 may, for example, be trained to perform toxicity detection, with higher reward values 102 corresponding to less toxic outputs.

The one or more processing devices 12 are further configured to select the constrained output token vocabulary 64 based at least in part on the one or more reward values 102. For example, the constrained output token vocabulary 64 may be selected to include each predicted completion token 96 generated at the beginning of a corresponding predicted completion 94 with a reward value 102 above the reward threshold 104.

By using a decoder plugin 60 that includes the reward model 100, the output 50 of the machine learning model 30 may be guided using a reward signal without having to perform additional training at the machine learning model 30. In contrast, RLHF relies on further training the machine learning model 30, which may be expensive. The configuration of FIG. 6 also allows a user to switch between different reward models 100. For example, different decoder plugins 60 with different respective reward models 100 may be used depending on whether the machine learning model 30 is instructed to generate text in a formal or casual writing style. In contrast to reapplying RLHF with a different reward model, which is slow and computationally expensive, substitution of the decoder plugin 60 to use a different reward model 100 may be performed quickly (e.g., partway through a use session in response to user input) and at low cost.

Although the examples of FIGS. 5A-6 discuss toxicity filtering, other types of safety controls may also be provided using the decoder plugin. Such safety controls may, for example, constrain the output token vocabulary 40 to prevent behaviors such as leaking of confidential information or generation of malicious code. An oversight machine learning model 90 included in the decoder plugin 60 may also be used to detect and inhibit unintended autonomous behaviors of the machine learning model 30, such as attempts by the machine learning model 30 to leak its own parameters or gain increased control over its hardware.

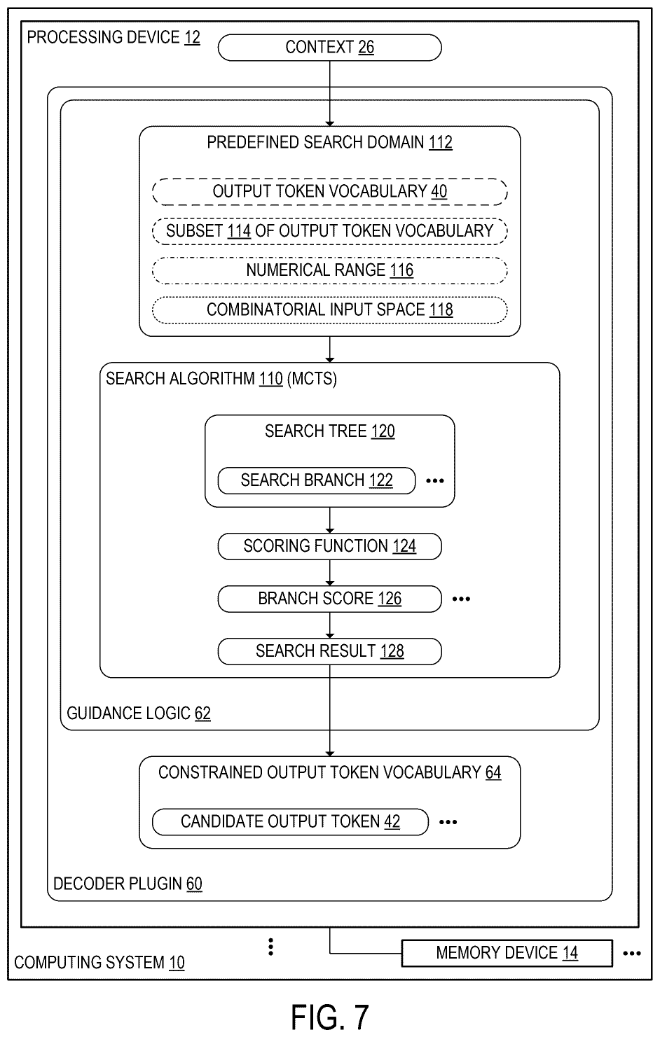

FIG. 7 schematically shows the computing system 10 in an example in which, at the decoder plugin 60, the one or more processing devices 12 are configured to execute a search algorithm 110 when computing the constrained output token vocabulary 64. In the example of FIG. 7, the one or more processing devices 12 are configured to perform a Monte Carlo tree search (MCTS) algorithm. In other examples, the one or more processing devices 12 may be configured to perform some other type of search algorithm, such as simulated annealing, simulated quantum annealing, parallel tempering, or an interacting Metropolis-Hastings algorithm, to name several non-limiting examples.

The one or more processing devices 12 are configured to execute the search algorithm 110 over a predefined search domain 112. The predefined search domain 112 may, for example, be a space of candidate output tokens 42. In some examples, the predefined search domain 112 may be the entire output token vocabulary 40 of the machine learning model 30. The predefined search domain 112 may be a subset 114 of the output token vocabulary 40 in some examples. For example, when the machine learning model 30 is used to perform mathematical reasoning, the subset 114 may include candidate output tokens 42 that frequently occur in mathematical expressions. The subset 114 may be specified via user input.

In other examples, instead of searching over a space of candidate output tokens 42, the one or more processing devices 12 may be configured to search over a numerical range 116 of values that are further processed at the guidance logic 62 to compute the constrained output token vocabulary 64. For example, the numerical range 116 may be a range of potential numerical values with which the machine learning model 30 can fill a field in a template, as in the example of FIG. 2. In other examples, the predefined search domain 112 may be a combinatorial input space 118 that includes candidate combinations of discrete values other than the candidate output tokens 42. For example, when the machine learning model 30 is used to prove a mathematical theorem, the combinatorial input space 118 may be a space of transformations that are performable on a mathematical expression.

In the example of FIG. 7, the one or more processing devices 12 are configured to construct a search tree 120 over the predefined search domain 112 that includes a plurality of search branches 122. The search branches 122 may, for example, be sequences of moves in a board game or sequences of steps in a proof. The one or more processing devices 12 may be configured to iteratively expand the search tree 120 over the course of searching through the predefined search domain 112.

When searching through the search tree 120, the one or more processing devices 12 are configured to assign respective branch scores 126 to the search branches 122. The branch scores 126 are each computed at a scoring function 124. In some examples, the scoring function 124 may be a machine learning model trained to perform a task such as evaluating which player is winning a board game. In other examples, the one or more processing devices 12 are configured to compute the branch scores 126 at a rule-based scoring function.

The one or more processing devices 12 are further configured to obtain a search result 128 from the search algorithm 110 and to select the constrained output token vocabulary 64 based at least in part on the search result 128. In examples in which the one or more processing devices 12 are configured to search over the output token vocabulary 40 or a subset 114 thereof, the search result 128 may directly specify one or more of the candidate output tokens 42 to include in or exclude from the constrained output token vocabulary 64. In other examples, the guidance logic 62 may further include one or more post-processing operations such as tokenization of numerical values. The one or more processing devices 12 are accordingly configured to incorporate the planning capabilities of the search algorithm 110 into the selection of the one or more output tokens 52 by using the search result 128 to guide the constraint the output token vocabulary 40.

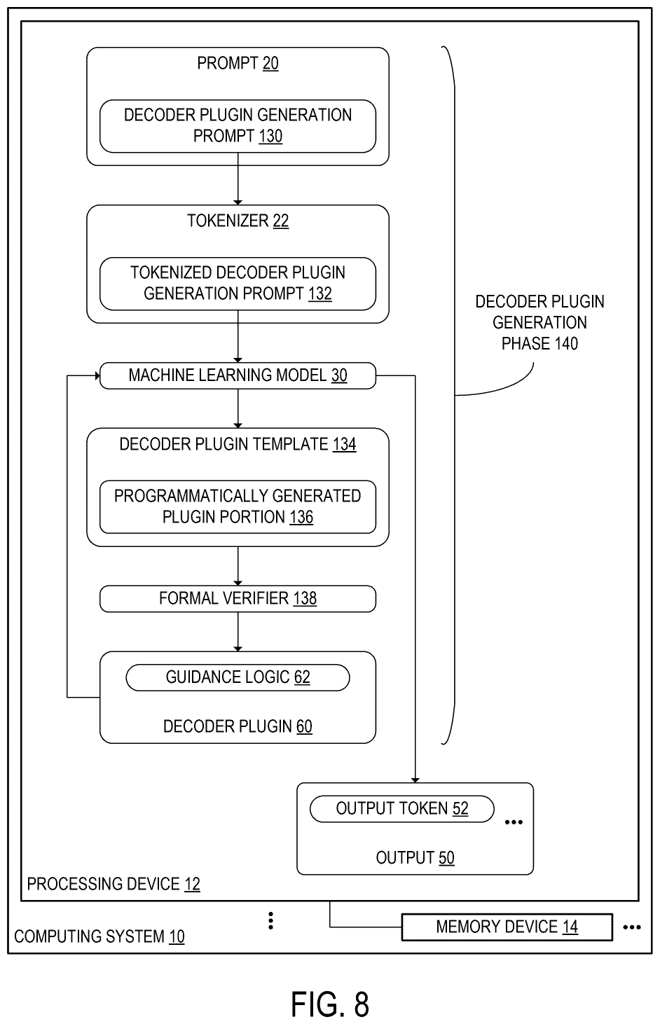

FIG. 8 schematically shows the computing system 10 in an example in which the decoder plugin 60 is generated at least in part at the machine learning model 30. The computing operations shown in the example of FIG. 8 may occur during a decoder plugin generation phase 140 performed prior to computing the constrained output token vocabulary 64. In some examples, the decoder plugin generation phase 140 is performed in a separate use session from the computation of the output 50, and the generated decoder plugin 60 is stored in the one or more memory devices 14 for later use. Alternatively, the decoder plugin generation phase 140 may be performed in the same use session as a preliminary stage of generating a response to the prompt 20.

In the decoder plugin generation phase 140, the one or more processing devices 12 are configured to receive a decoder plugin generation prompt 130. For example, the decoder plugin generation prompt 130 may be received as user input and may be a portion of the prompt 20 for which the machine learning model 30 is configured to generate the output 50 using the constrained output token vocabulary 64. The decoder plugin generation prompt 130 may specify, in natural language, instructions to generate at least a portion of the decoder plugin 60. For example, the decoder plugin generation prompt 130 may be a label that is assigned to a field in a template and that states “This part of the output must be syntactically valid Python.” The one or more processing devices 12 are further configured to compute a tokenized decoder plugin generation prompt 132 at the tokenizer 22.

The one or more processing devices 12 are further configured to input the tokenized decoder plugin generation prompt 132 into the machine learning model 30. At the machine learning model 30, based at least in part on the tokenized decoder plugin generation prompt 132, the one or more processing devices 12 are further configured to compute at least a portion 136 of the decoder plugin 60. For example, the machine learning model 30 may compute the programmatically generated plugin portion 136 as a filled field of a decoder plugin template 134. The decoder plugin template 134, in such examples, also includes previously generated portions that specify the structure of the decoder plugin 60. In some examples, rather than generating the programmatically generated plugin portion 136 at the machine learning model 30, the one or more processing devices 12 may be configured to generate the programmatically generated plugin portion 136 at a different machine learning model.

In some examples, the one or more processing devices 12 may be further configured to execute a formal verifier 138 during the decoder plugin generation phase 140. The formal verifier 138 is configured to receive the programmatically generated plugin portion 136 as input and to programmatically check one or more properties of the programmatically generated plugin portion 136. For example, the formal verifier 138 may be a type checker. When the programmatically generated plugin portion 136 passes one or more verification checks performed at the formal verifier 138, the programmatically generated plugin portion 136 may be included in the decoder plugin 60. The machine learning model 30 may be configured to regenerate the programmatically generated plugin portion 136 if the programmatically generated plugin portion 136 fails the one or more verification checks.

As discussed above, after the programmatically generated plugin portion 136 has been computed and verified, the one or more processing devices may be further configured to use the decoder plugin 60 to constrain the outputs 50 of the machine learning model 30. Thus, the machine learning model 30 may be used to convert properties specified in unstructured user input into constraints on its output token vocabulary 40.

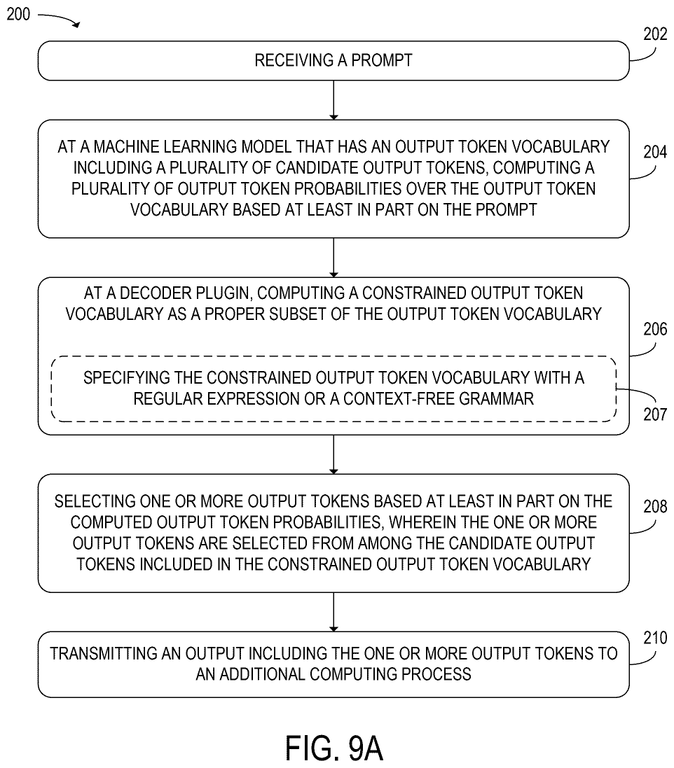

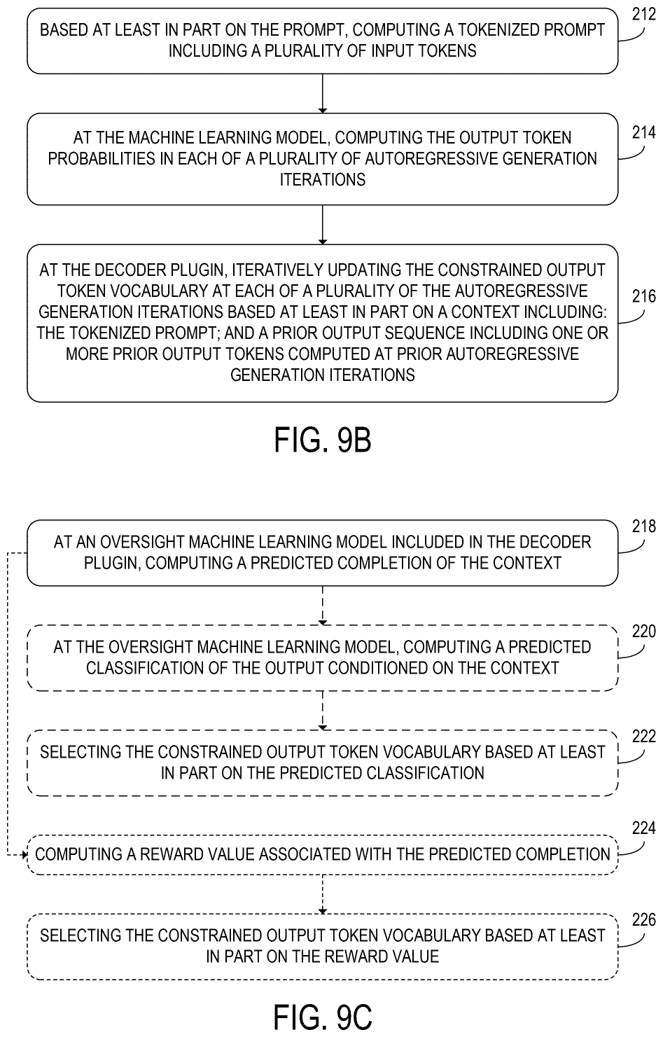

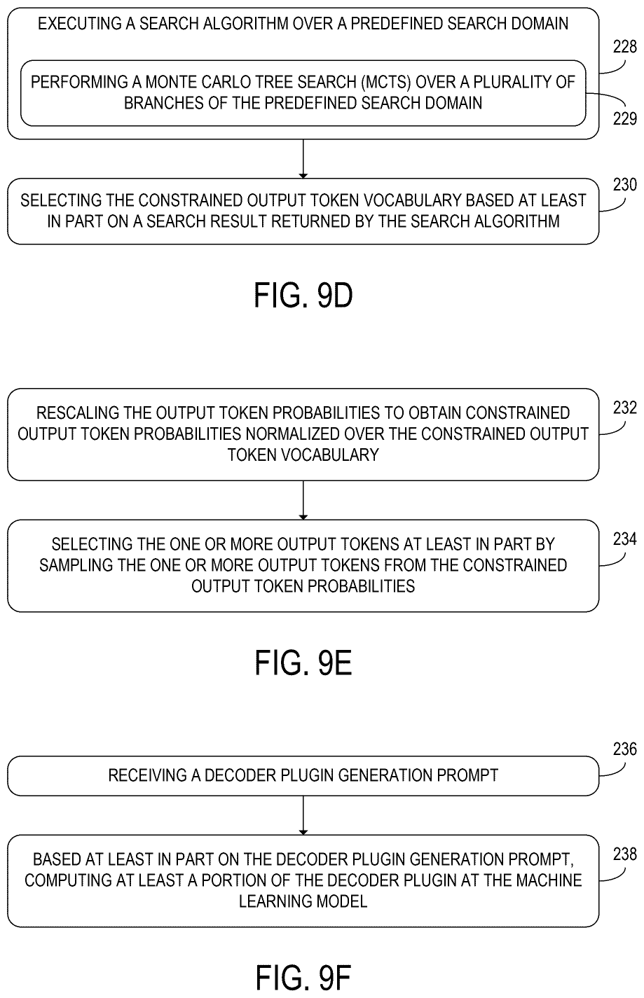

FIG. 9A shows a flowchart of a method 200 for use with a computing system to constrain the output token vocabulary of a machine learning model. At step 202, the method 200 includes receiving a prompt. For example, the prompt may be received at the computing system as user input in the form of natural language.

Step 204 of the method 200 is performed at a machine learning model. For example, the machine learning model may be a deep neural network that has a transformer architecture. This machine learning model has an output token vocabulary including a plurality of candidate output tokens that are eligible to be included in its outputs. At step 204, the method 200 further includes computing a plurality of output token probabilities over the output token vocabulary based at least in part on the prompt. The output token probabilities are associated with respective candidate output tokens.

At step 206, the method 200 further includes computing a constrained output token vocabulary at a decoder plugin. The constrained output token vocabulary is computed as a proper subset of the output token vocabulary. In some examples, at step 207, step 206 includes specifying the constrained output token vocabulary with a regular expression or a context-free grammar. In other examples, the constrained output token vocabulary may be computed using guidance logic written in a Turing-complete language.

At step 208, the method 200 further includes selecting one or more output tokens based at least in part on the computed output token probabilities. The one or more output tokens may be probabilistically sampled from the distribution of output token probabilities at a sampler included in a decoding module of the machine learning model. The one or more output tokens are selected from among the candidate output tokens included in the constrained output token vocabulary. Thus, the decoder plugin guides the generation of the output tokens by narrowing the output token vocabulary from which the output tokens are eligible to be selected.

At step 210, the method 200 further includes transmitting an output including the one or more output tokens to an additional computing process. For example, the output may be transmitted for display to a user at a GUI. As another example, the output may be transmitted to a compiler to be compiled into assembly-level instructions.

FIGS. 9B-9F show additional steps of the method 200 of FIG. 9A that may be performed in some examples. Step 212, as shown in FIG. 9B, may be performed subsequently to receiving the prompt and step 202 and prior to computing the output token probabilities at step 204. At step 212, the method 200 may further include computing a tokenized prompt based at least in part on the prompt. The tokenized prompt may include a plurality of input tokens.

At step 214, the method 200 may further include computing the output token probabilities at the machine learning model in each of a plurality of autoregressive generation iterations. At each of the autoregressive generation iterations, the machine learning model may compute a respective output token probability distribution that is sampled to obtain a corresponding output token.

At step 216, the method 200 may further include iteratively updating the constrained output token vocabulary at the decoder plugin at each of a plurality of the autoregressive generation iterations. In some examples, the decoder plugin may update the constrained output token vocabulary at each autoregressive generation iteration after a first autoregressive generation iteration, whereas in other examples, the decoder plugin may update the constrained output token vocabulary less frequently. The guidance logic may include logic specifying an update schedule for the constrained output token vocabulary. When the constrained output token vocabulary is updated, the decoder plugin may update the constrained output token vocabulary based at least in part on a context including the tokenized prompt and a prior output sequence. The prior output sequence may include one or more prior output tokens computed at one or more respective prior autoregressive generation iterations. Thus, the constrained output token vocabulary may be iteratively modified to reflect the addition of output tokens to the context.

FIG. 9C shows additional steps of the method 200 that may be performed in some examples in which the decoder plugin includes an oversight machine learning model. At the oversight machine learning model, the method 200 may further include, at step 218, computing a predicted completion of the context. The predicted completion may include one or more predicted completion tokens selected from the output token vocabulary. In some examples, the oversight machine learning model may compute a plurality of predicted completions.

Steps 220 and 222 may be performed in examples in which the oversight machine learning model is a classifier. At step 220, the method 200 may further include, at the oversight machine learning model, computing a predicted classification of the output conditioned on the context. For example, the oversight machine learning model may predict a classification of the output as harmful or not harmful. In examples in which the oversight machine learning model predicts a plurality of predicted completions, the oversight machine learning model may compute a respective predicted classification associated with each of those predicted completions.

At step 222, the method 200 may further include selecting the constrained output token vocabulary based at least in part on the predicted classification. For example, the decoder plugin may exclude a candidate output token from the constrained output token vocabulary if the predicted completion beginning with that candidate output token has a probability of being harmful that is above a predefined probability threshold. In some examples in which the oversight machine learning model computes a plurality of predicted completions and corresponding predicted classifications, step 222 may include constructing the constrained output token vocabulary from the set of candidate output tokens that are begin respective predicted completions and have token-specific predicted classifications below the predefined probability threshold. The constrained output token vocabulary, in such examples, is accordingly constructed from candidate output tokens that are unlikely to lead to toxic outputs.

In some examples, the decoder plugin may include an oversight machine learning model that computes a predicted classification without computing a predicted completion of the context. The predicted classification may be used to select the constrained output token vocabulary as discussed above, but without the additional information provided by the predicted completions.

In some examples, reward predictions rather than classifications may be used to select the constrained output token vocabulary. At step 224, subsequently to computing the predicted completion at step 218, the method 200 may further include computing a reward value associated with the predicted completion. The reward value may be computed at a reward model, which may be a machine learning model in some examples.

In examples in which step 224 is performed, the method 200 may further include, at step 226, selecting the constrained output token vocabulary based at least in part on the reward value. In examples in which the decoder plugin generates a plurality of predicted completions, the candidate output tokens selected for inclusion in the constrained output token vocabulary may, for example, be the candidate output tokens that begin predicted completions with reward values above a predefined reward threshold. As another example, a predefined number of top reward values may be selected, and the candidate output tokens that begin the corresponding predicted completions may be selected for inclusion in the constrained output token vocabulary.

FIG. 9D shows other steps of the method 200 that may be performed at the decoder plugin in some examples. At step 228, the method 200 may further include executing a search algorithm over a predefined search domain. The predefined search domain may, for example, be the output token vocabulary, a subset of the output token vocabulary, or some other search domain such as a numerical range. In some examples, at step 229, step 228 includes performing an MCTS over a plurality of branches of the predefined search domain. In other examples, some other search algorithm may be used.

At step 230, the method 200 may further include selecting the constrained output token vocabulary based at least in part on a search result returned by the search algorithm. For example, when the predefined search domain is a domain of candidate output tokens, the search result may be an identification of one or more candidate output tokens to include in or exclude from the constrained output token vocabulary. In other examples, the search result such as a numerical value may be post-processed in a manner that maps the search result to one or more of the candidate output tokens.

FIG. 9E shows additional steps of the method 200 that may be performed at a decoding module of the machine learning model. At step 232, the method 200 may further include rescaling the output token probabilities to obtain constrained output token probabilities normalized over the constrained output token vocabulary. Thus, the output token probabilities may be adjusted to reflect the narrowing of the output token vocabulary. At step 234, the method 200 may further include selecting the one or more output tokens at least in part by sampling the output tokens from the constrained output token probabilities.

FIG. 9F shows additional steps of the method 200 that may be performed during a decoder plugin generation phase. In examples in which the steps of FIG. 9F are performed, the decoder plugin generation phase is performed prior to computing the constrained output token vocabulary. The method 200 may further include, at step 236, receiving a decoder plugin generation prompt. The decoder plugin generation prompt may, for example, be specified in natural language via user input.

At step 238, the method 200 may further include computing at least a portion of the decoder plugin at the machine learning model based at least in part on the decoder plugin generation prompt. For example, the machine learning model may fill one or more fields of a decoder plugin template. The machine learning model may accordingly generate guidance logic from unstructured user input.

Using the systems and methods discussed above, the output token vocabulary of a machine learning model is constrained at a decoder plugin in order to guide the generation of its output. The output vocabulary may, for example, be constrained using the systems and methods discussed above in order to provide safety controls for the machine learning model. Constraining the output token vocabulary may also reduce hallucinations by decreasing autoregressive drift. In addition, by performing a search algorithm at the decoder plugin, strategic planning may be incorporated into the selection of the constrained output token vocabulary. Since planning is typically difficult for existing LLMs and LMMs, constraining the output token vocabulary may increase the usability of the machine learning model for tasks that involve planning.

The decoder plugin that is used to compute the constrained output token vocabulary may be switched out or modified to change the vocabulary constraint behavior without having to perform additional training at the machine learning model. Output token vocabulary constraint therefore provides flexible, low-cost options for controlling the outputs of the machine learning model in ways that are difficult to achieve with prompting.

The methods and processes described herein are tied to a computing system of one or more computing devices. In particular, such methods and processes can be implemented as a computer-application program or service, an application-programming interface (API), a library, and/or other computer-program product.

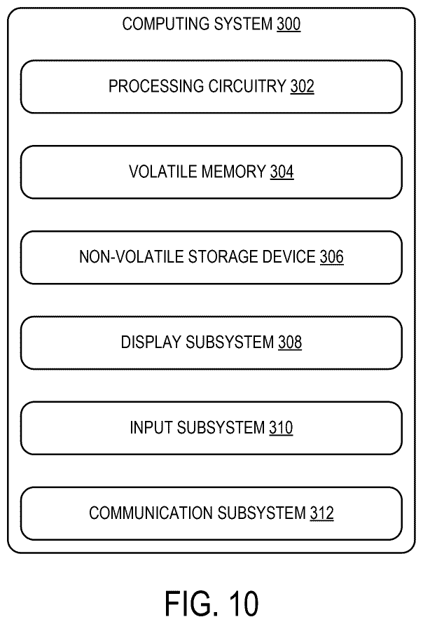

FIG. 10 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 10.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive a prompt. At a machine learning model that has an output token vocabulary including a plurality of candidate output tokens, the one or more processing devices are further configured to compute a plurality of output token probabilities over the output token vocabulary based at least in part on the prompt. At a decoder plugin, the one or more processing devices are further configured to compute a constrained output token vocabulary as a proper subset of the output token vocabulary. The one or more processing devices are further configured to select one or more output tokens based at least in part on the computed output token probabilities. The one or more output tokens are selected from among the candidate output tokens included in the constrained output token vocabulary. The one or more processing devices are further configured to transmit an output including the one or more output tokens to an additional computing process. The above features may have the technical effect of guiding the generation of the output by the machine learning model. This output guidance may allow for additional control over the contents of the output and may be used to reduce autoregressive drift.

According to this aspect, the one or more processing devices may be further configured to, based at least in part on the prompt, compute a tokenized prompt including a plurality of input tokens. At the machine learning model, the one or more processing devices may be further configured to compute the output token probabilities in each of a plurality of autoregressive generation iterations. At the decoder plugin, the one or more processing devices may be further configured to iteratively update the constrained output token vocabulary at each of a plurality of the autoregressive generation iterations based at least in part on a context including the tokenized prompt and a prior output sequence including one or more prior output tokens computed at prior autoregressive generation iterations. The above features may have the technical effect of modifying the manner in which the output token sequence is guided over the course of generating the output.

According to this aspect, the decoder plugin may include an oversight machine learning model. The one or more processing devices may be further configured to, at the oversight machine learning model, compute a predicted classification of the output conditioned on the context. The one or more processing devices may be further configured to select the constrained output token vocabulary based at least in part on the predicted classification. The above features may have the technical effect of constraining the output token vocabulary in a flexible manner that accounts for complex behaviors that may occur at the machine learning model. For example, the oversight machine learning model may be used to perform scalable oversight for alignment purposes.

According to this aspect, at the oversight machine learning model, the one or more processing devices may be further configured to compute a predicted completion of the context. The one or more processing devices may be further configured to compute the predicted classification based at least in part on the predicted completion. The above features may have the technical effect of constraining the output token vocabulary based at least in part on estimates of later output tokens, as approximated at the oversight machine learning model.

According to this aspect, the decoder plugin may include an oversight machine learning model. The one or more processing devices may be further configured to, at the oversight machine learning model, compute a predicted completion of the context. The one or more processing devices may be further configured to compute a reward value associated with the predicted completion. The one or more processing devices may be further configured to select the constrained output token vocabulary based at least in part on the reward value. The above features may have the technical effect of constraining the output token vocabulary in a manner that is estimated to have a high reward value according to a specified reward function.

According to this aspect, at the decoder plugin, the one or more processing devices may be further configured to modify one or more sampling parameters of the machine learning model. The above features may have the technical effect of increasing the consistency or the variability of the output tokens when the output tokens are sampled from the constrained output token vocabulary, or of modifying the sampling of the output tokens in some other manner.

According to this aspect, at the decoder plugin, the one or more processing devices may be further configured to execute a search algorithm over a predefined search domain. The one or more processing devices may be further configured to select the constrained output token vocabulary based at least in part on a search result returned by the search algorithm. The above features may have the technical effect of utilizing a search algorithm as an additional mechanism of guiding the output of the machine learning model.

According to this aspect, when executing the search algorithm at the decoder plugin, the one or more processing devices may be configured to perform a Monte Carlo tree search (MCTS) over a plurality of branches of the predefined search domain. The above features may have the technical effect of planning over a search domain of potential future outputs when selecting the constrained output token vocabulary.

According to this aspect, at the decoder plugin, the one or more processing devices may be configured to specify the constrained output token vocabulary with a regular expression or a context-free grammar. The above features may have the technical effect of specifying a structure with which the output tokens in the constrained output token vocabulary are selected.

According to this aspect, at the machine learning model, the one or more processing devices may be further configured to rescale the output token probabilities to obtain constrained output token probabilities normalized over the constrained output token vocabulary. The one or more processing devices may be further configured to select the one or more output tokens at least in part by sampling the output tokens from the constrained output token probabilities. The above features may have the technical effect of adjusting the output token probabilities to account for the change in the output token vocabulary.

According to this aspect, during a decoder plugin generation phase performed prior to computing the constrained output token vocabulary, the one or more processing devices may be further configured to receive a decoder plugin generation prompt. The one or more processing devices may be further configured to, based at least in part on the decoder plugin generation prompt, compute at least a portion of the decoder plugin at the machine learning model. The above features may have the technical effect of programmatically generating at least a portion of the decoder plugin as specified by a user input.

According to another aspect of the present disclosure, a method for use with a computing system is provided. The method includes receiving a prompt. The method further includes, at a machine learning model that has an output token vocabulary including a plurality of candidate output tokens, computing a plurality of output token probabilities over the output token vocabulary based at least in part on the prompt. At a decoder plugin, the method further includes computing a constrained output token vocabulary as a proper subset of the output token vocabulary. The method further includes selecting one or more output tokens based at least in part on the computed output token probabilities. The one or more output tokens are selected from among the candidate output tokens included in the constrained output token vocabulary. The method further includes transmitting an output including the one or more output tokens to an additional computing process. The above features may have the technical effect of guiding the generation of the output by the machine learning model. This output guidance may allow for additional control over the contents of the output and may be used to reduce autoregressive drift.

According to this aspect, based at least in part on the prompt, the method may further include computing a tokenized prompt including a plurality of input tokens. At the machine learning model, the method may further include computing the output token probabilities in each of a plurality of autoregressive generation iterations. At the decoder plugin, the method may further include iteratively updating the constrained output token vocabulary at each of a plurality of the autoregressive generation iterations based at least in part on a context including the tokenized prompt and a prior output sequence including one or more prior output tokens computed at prior autoregressive generation iterations. The above features may have the technical effect of modifying the manner in which the output token sequence is guided over the course of generating the output.

According to this aspect, the decoder plugin may include an oversight machine learning model. The method may further include, at the oversight machine learning model, computing a predicted classification of the output conditioned on the context. The method may further include selecting the constrained output token vocabulary based at least in part on the predicted classification. The above features may have the technical effect of constraining the output token vocabulary in a flexible manner that accounts for complex behaviors that may occur at the machine learning model. For example, the oversight machine learning model may be used to perform scalable oversight for alignment purposes.

According to this aspect, the decoder plugin may include an oversight machine learning model. The method may further include, at the oversight machine learning model, computing a predicted completion of the context. The method may further include computing a reward value associated with the predicted completion. The method may further include selecting the constrained output token vocabulary based at least in part on the reward value. The above features may have the technical effect of constraining the output token vocabulary in a manner that is estimated to have a high reward value according to a specified reward function.

According to this aspect, at the decoder plugin, the method may further include executing a search algorithm over a predefined search domain. The method may further include selecting the constrained output token vocabulary based at least in part on a search result returned by the search algorithm. The above features may have the technical effect of utilizing a search algorithm as an additional mechanism of guiding the output of the machine learning model.

According to this aspect, the method may further include, at the decoder plugin, specifying the constrained output token vocabulary with a regular expression or a context-free grammar. The above features may have the technical effect of specifying a structure with which the output tokens in the constrained output token vocabulary are selected.

According to this aspect, the method may further include, at the machine learning model, rescaling the output token probabilities to obtain constrained output token probabilities normalized over the constrained output token vocabulary. The method may further include selecting the one or more output tokens at least in part by sampling the output tokens from the constrained output token probabilities. The above features may have the technical effect of adjusting the output token probabilities to account for the change in the output token vocabulary.

According to this aspect, the method may further include, during a decoder plugin generation phase performed prior to computing the constrained output token vocabulary, receiving a decoder plugin generation prompt. The method may further include, based at least in part on the decoder plugin generation prompt, computing at least a portion of the decoder plugin at the machine learning model. The above features may have the technical effect of programmatically generating at least a portion of the decoder plugin as specified by a user input.

According to another aspect of the present disclosure, a computing system is provided, including one or more processing devices configured to receive a prompt. At a machine learning model that has an output token vocabulary including a plurality of candidate output tokens, the one or more processing devices are further configured to compute a plurality of output token probabilities over the output token vocabulary based at least in part on the prompt. At a decoder plugin, the one or more processing devices are further configured to modify respective output token probabilities associated with the plurality of candidate output tokens to thereby obtain constrained output token probabilities. The one or more processing devices are further configured to select one or more output tokens based at least in part on the constrained output token probabilities. The one or more processing devices are further configured to transmit an output including the one or more output tokens to an additional computing process. The above features may have the technical effect of guiding the generation of the output by the machine learning model. This output guidance may allow for additional control over the contents of the output and may be used to reduce autoregressive drift.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a prompt;
at a machine learning model that has an output token vocabulary including a plurality of candidate output tokens, compute a plurality of output token probabilities over the output token vocabulary based at least in part on the prompt;
at a decoder plugin, compute a constrained output token vocabulary as a proper subset of the output token vocabulary;
select one or more output tokens based at least in part on the computed output token probabilities, wherein the one or more output tokens are selected from among the candidate output tokens included in the constrained output token vocabulary; and
transmit an output including the one or more output tokens to an additional computing process.

2. The computing system of claim 1, wherein the one or more processing devices are further configured to:
based at least in part on the prompt, compute a tokenized prompt including a plurality of input tokens;
at the machine learning model, compute the output token probabilities in each of a plurality of autoregressive generation iterations; and
at the decoder plugin, iteratively update the constrained output token vocabulary at each of a plurality of the autoregressive generation iterations based at least in part on a context including:
the tokenized prompt; and
a prior output sequence including one or more prior output tokens computed at prior autoregressive generation iterations.

3. The computing system of claim 2, wherein:
the decoder plugin includes an oversight machine learning model; and
the one or more processing devices are further configured to:
at the oversight machine learning model, compute a predicted classification of the output conditioned on the context; and
select the constrained output token vocabulary based at least in part on the predicted classification.

4. The computing system of claim 3, wherein, at the oversight machine learning model, the one or more processing devices are further configured to:
compute a predicted completion of the context; and
compute the predicted classification based at least in part on the predicted completion.

5. The computing system of claim 2, wherein:
the decoder plugin includes an oversight machine learning model; and
the one or more processing devices are further configured to:
at the oversight machine learning model, compute a predicted completion of the context;
compute a reward value associated with the predicted completion; and
select the constrained output token vocabulary based at least in part on the reward value.

6. The computing system of claim 1, wherein, at the decoder plugin, the one or more processing devices are further configured to modify one or more sampling parameters of the machine learning model.

7. The computing system of claim 1, wherein, at the decoder plugin, the one or more processing devices are further configured to:
execute a search algorithm over a predefined search domain; and
select the constrained output token vocabulary based at least in part on a search result returned by the search algorithm.

8. The computing system of claim 7, wherein, when executing the search algorithm at the decoder plugin, the one or more processing devices are configured to perform a Monte Carlo tree search (MCTS) over a plurality of branches of the predefined search domain.

9. The computing system of claim 1, wherein, at the decoder plugin, the one or more processing devices are configured to specify the constrained output token vocabulary with a regular expression or a context-free grammar.

10. The computing system of claim 1, wherein, at the machine learning model, the one or more processing devices are further configured to:
rescale the output token probabilities to obtain constrained output token probabilities normalized over the constrained output token vocabulary; and
select the one or more output tokens at least in part by sampling the output tokens from the constrained output token probabilities.

11. The computing system of claim 1, wherein, during a decoder plugin generation phase performed prior to computing the constrained output token vocabulary, the one or more processing devices are further configured to:
receive a decoder plugin generation prompt; and
based at least in part on the decoder plugin generation prompt, compute at least a portion of the decoder plugin at the machine learning model.

12. A method for use with a computing system, the method comprising:
receiving a prompt;
at a machine learning model that has an output token vocabulary including a plurality of candidate output tokens, computing a plurality of output token probabilities over the output token vocabulary based at least in part on the prompt;
at a decoder plugin, computing a constrained output token vocabulary as a proper subset of the output token vocabulary;
selecting one or more output tokens based at least in part on the computed output token probabilities, wherein the one or more output tokens are selected from among the candidate output tokens included in the constrained output token vocabulary; and
transmitting an output including the one or more output tokens to an additional computing process.

13. The method of claim 12, further comprising:
based at least in part on the prompt, computing a tokenized prompt including a plurality of input tokens;
at the machine learning model, computing the output token probabilities in each of a plurality of autoregressive generation iterations; and
at the decoder plugin, iteratively updating the constrained output token vocabulary at each of a plurality of the autoregressive generation iterations based at least in part on a context including:
the tokenized prompt; and
a prior output sequence including one or more prior output tokens computed at prior autoregressive generation iterations.

14. The method of claim 13, wherein:
the decoder plugin includes an oversight machine learning model; and
the method further comprises:
at the oversight machine learning model, computing a predicted classification of the output conditioned on the context; and
selecting the constrained output token vocabulary based at least in part on the predicted classification.

15. The method of claim 13, wherein:
the decoder plugin includes an oversight machine learning model; and
the method further includes:
at the oversight machine learning model, computing a predicted completion of the context;
computing a reward value associated with the predicted completion; and
selecting the constrained output token vocabulary based at least in part on the reward value.

16. The method of claim 12, further comprising, at the decoder plugin:
executing a search algorithm over a predefined search domain; and
selecting the constrained output token vocabulary based at least in part on a search result returned by the search algorithm.

17. The method of claim 12, further comprising, at the decoder plugin, specifying the constrained output token vocabulary with a regular expression or a context-free grammar.

18. The method of claim 12, further comprising, at the machine learning model:
rescaling the output token probabilities to obtain constrained output token probabilities normalized over the constrained output token vocabulary; and
selecting the one or more output tokens at least in part by sampling the output tokens from the constrained output token probabilities.

19. The method of claim 12, further comprising, during a decoder plugin generation phase performed prior to computing the constrained output token vocabulary:
receiving a decoder plugin generation prompt; and
based at least in part on the decoder plugin generation prompt, computing at least a portion of the decoder plugin at the machine learning model.

20. A computing system comprising:
one or more processing devices configured to:
receive a prompt;
at a machine learning model that has an output token vocabulary including a plurality of candidate output tokens, compute a plurality of output token probabilities over the output token vocabulary based at least in part on the prompt;
at a decoder plugin, modify respective output token probabilities associated with the plurality of candidate output tokens to thereby obtain constrained output token probabilities;
select one or more output tokens based at least in part on the constrained output token probabilities; and
transmit an output including the one or more output tokens to an additional computing process.
